(19) United States
(12) Patent Application Publication
(10) Pub. No.: US 2020/0067086 A1
(43) Pub. Date: Feb. 27, 2020

(54) ANODE FOR SULFIDE ALL-SOLID-STATE BATTERIES, AND SULFIDE ALL-SOLID-STATE BATTERY

(71) Applicant: TOYOTA JIDOSHA KABUSHIKI KAISHA, Toyota-shi (JP)

(72) Inventor: Satoshi MIZUTANI, Okazaki-shi (JP)

(73) Assignee: TOYOTA JIDOSHA KABUSHIKI KAISHA, Toyota-shi (JP)

(21) Appl. No.: 16/539,469

(22) Filed: Aug. 13, 2019

(30) Foreign Application Priority Data
Aug. 21, 2018 (JP) 2018-154795

(51) Int. Cl. H01M 4/38; H01M 10/0525; H01M 10/0562; C01G 49/12; H01M 4/58; H01M 4/62; H01M 4/134; H01M 4/133; H01M 4/36; H01M 4/1393

(52) U.S. Cl. CPC H01M 4/386; H01M 10/0525; H01M 10/0562; C01G 49/12; H01M 4/5815; H01M 2300/0065; H01M 4/134; H01M 4/133; H01M 4/364; H01M 4/1393; H01M 4/621

(57) ABSTRACT

Provided is an anode for sulfide all-solid-state batteries, which is configured to suppress the expansion of the anode during charge, though a Si-based anode active material is used. Also provided is a sulfide all-solid-state battery including the anode. The anode for sulfide all-solid-state batteries may be an anode for sulfide all-solid-state batteries, wherein the anode includes anode material particles, and wherein each anode material particle includes a laminate which includes void layers and Si-based material layers containing at least one Si-based material selected from the group consisting of Si and a Si alloy, and in which the Si-based material layers and the void layers are alternately laminated, and a coat film covering a surface of the laminate to cover at least the void layers.

### TECHNICAL FIELD

The disclosure relates to an anode for sulfide all-solid-state batteries and a sulfide all-solid-state battery.

### BACKGROUND

In the field of lithium ion batteries, recently, it was proposed to use a Si-based anode active material, for the purpose of increasing energy density, in place of a widely-used, carbon-based anode active material.

For example, a lithium ion secondary battery comprising an electrolyte solution is disclosed in Patent Literature 1, in which, for the purpose of obtaining high capacity and suppressing temperature rise during overcharge, an anode active material that mainly contains silicon and silicon oxide is used, and the amount of hydrofluoric acid in the electrolyte solution is controlled, whereby the degree of hydrogenation of the terminal of the dangling bond of the silicon is controlled, and the anode active material obtains a predetermined absorbance.

Patent Literature 2 discloses an anode member for lithium ion secondary batteries, which contains, for the purpose of suppressing deterioration of battery characteristics due to a change in the volume of silicon particles associated with charge and discharge, an anode active material powder containing a silicon powder in which the powder particles are covered with a carbon coating film, an electroconductive carbon powder having a specific size, and electroconductive carbon fibers having a specific size.

However, compared to the widely-used, carbon-based anode active material, the Si-based anode active material undergoes a large volume change during Li intercalation. Accordingly, an all-solid-state battery comprising the Si-based anode active material has a problem in that it is difficult to ease the propagation of stress and strain to the solid electrolyte, both of which are due to the expansion and contraction of the anode active material, and the solid electrolyte may be cracked by the expansion and contraction of the anode active material.

Accordingly, Patent Literature 3 discloses an anode for all-solid-state batteries, which comprises a sulfide solid electrolyte and an anode active material and in which the anode active material is complex particles containing a carbon material including Si or Sn; the particle diameter of the Si or Sn is a specific value or less; the particle diameter of the anode active material is a specific value or less; and the voidage of the anode is in a specific range.

Patent Literature 1: Japanese Patent Application Laid-Open (JP-A) No. 2013-229302

Patent Literature 2: JP-A No. 2011-18575

Patent Literature 3: JP-A No. 2017-54720

In some cases, to suppress an increase in volume during charge, an all-solid state battery with high capacity is used in such a state that confining pressure is applied thereto by a confining jig. However, a conventional all-solid-state battery including an anode that contains a Si-based anode active material, has the following problem: since a pressure applied to the confining jig is increased by the expansion of the anode active material during charge, it is difficult to design the confining jig, and since a need for the high-strength confining jig leads to an enlargement of the size of the confining jig, an increase in the volume occupied by components other than the battery, is caused inside the battery system.

### SUMMARY

In light of the above circumstance, an object of the disclosed embodiments is to provide an anode for sulfide all-solid-state batteries, which is configured to suppress the expansion of the anode during charge, though a Si-based anode active material is used. Another object of the disclosed embodiments is to provide a sulfide all-solid-state battery comprising the anode.

In a first embodiment, there is provided an anode for sulfide all-solid-state batteries, wherein the anode comprises anode material particles, and wherein each anode material particle comprises a laminate which comprises void layers and Si-based material layers containing at least one Si-based material selected from the group consisting of Si and a Si alloy, and in which the Si-based material layers and the void layers are alternately laminated, and a coat film covering a surface of the laminate to cover at least the void layers.

The coat film may contain a carbonaceous material.

A thickness of each Si-based material layer may 50 nm or more and 500 nm or less, and a thickness of each void layer may be 10% or more of an average thickness of the Si-based material layers.

A median diameter (D50) of the anode material particles may be 2 μm or more and 20.5 μm or less.

Each anode material particle may further comprise solid electrolyte material layers containing a solid electrolyte material, and on void layer-side surfaces of the Si-based material layers of the laminate, the solid electrolyte material layers may be disposed adjacent to the void layers.

A thickness of each solid electrolyte material layer may be 10% or more and 50% or less of the average thickness of the Si-based material layers.

In another embodiment, there is provided a sulfide all-solid-state battery comprising the above-described anode for sulfide all-solid-state batteries.

According to the disclosed embodiments, each anode material particle comprises a laminate which comprises void layers and Si-based material layers containing at least one Si-based material selected from the group consisting of Si and a Si alloy, and in which the Si-based material layers and the void layers are alternately laminated, and each anode material particle comprises a coat film covering a surface of the laminate to cover at least the void layers, whereby providing the anode for sulfide all-solid-state batteries, which is configured to suppress the expansion of the anode during charge, though the Si-based anode active material is used, and also providing the sulfide all-solid-state battery comprising the anode.

### BRIEF DESCRIPTION OF THE DRAWINGS

In the accompanying drawings,

FIG. 1 is a schematic enlarged cross-sectional view of an example of the anode for sulfide all-solid-state batteries according to the disclosed embodiments;

FIG. 2 is a schematic enlarged cross-sectional view of another example of the anode for sulfide all-solid-state batteries according to the disclosed embodiments; and

FIG. 3 is a schematic cross-sectional view of an example of the sulfide all-solid-state battery according to the disclosed embodiments.

### DETAILED DESCRIPTION

1. Anode for Sulfide all-Solid-State Batteries

The anode for sulfide all-solid-state batteries according to the disclosed embodiments is an anode for sulfide all-solid-state batteries, wherein the anode comprises anode material particles, and wherein each anode material particle comprises a laminate which comprises void layers and Si-based material layers containing at least one Si-based material selected from the group consisting of Si and a Si alloy, and in which the Si-based material layers and the void layers are alternately laminated, and each anode material particle comprises a coat film covering a surface of the laminate to cover at least the void layers.

The anode for sulfide all-solid-state batteries according to the disclosed embodiments is typically used in a lithium ion battery. In the anode of the lithium ion battery using the Si-based anode active material, a so-called electrochemical alloying reaction represented by the following formula (1) is developed by charge, and a Li ion extraction reaction represented by the following formula (2), which is extraction of Li ions from a Si—Li alloy, is developed by discharge:

xLi⁺+xe+ySi→LiₓSi_{y} Formula (1):

LiₓSi_{y}→xLi⁺+xe+ySi Formula (2):

The anode comprising the Si-based anode active material has high energy density compared to a conventional anode comprising a carbon-based anode active material. The Si-based anode active material undergoes a large volume change during the Li insertion shown in the above formula (1), and it is known that the Si-based anode active material expands to 3 or 4 times its original size, compared to the carbon-based anode active material. In the anode of Patent Literature 3, a space to buffer the expansion of the anode active material caused by a reaction between the anode active material and Li, is ensured in advance by providing voids at a specific voidage. However, in the case of the anode in which voids are randomly arranged, there is a possibility that the anode active material expands in an area where sufficient voids are not ensured, or the anode active material does not expand to the inside of the voids and expands to the anode surface. Accordingly, it is desirable that the anode expansion is further suppressed.

Due to the use of the anode material particles that are suppressed from expansion during charge, the expansion of the anode of the disclosed embodiments during charge, is further suppressed compared to conventional anodes.

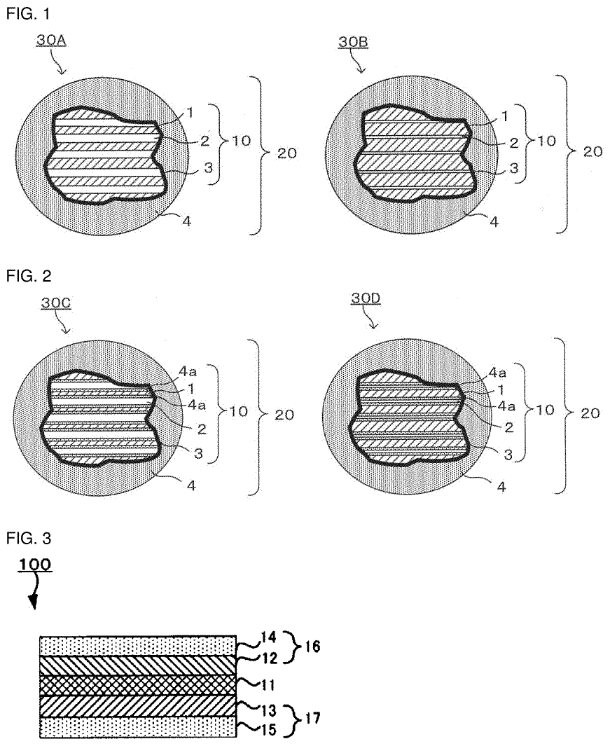

In the anode for sulfide all-solid-state batteries according to the disclosed embodiments, the Si-based anode active material is contained in the form of Si-based material layers inside the anode material particles. When the anode active material is expanded by charge, the Si-based material layers show a high expansion rate in the thickness direction, rather than the plane direction. For the anode material particles used in the disclosed embodiments, the Si-based material layers and the void layers are alternately laminated in the laminate inside each particle. Accordingly, the void layers function as free spaces allowing the expansion of the Si-based material layers at a high expansion rate in the thickness direction, and the void layers fully absorb the expansion of the Si-based material layers. Accordingly, it is presumed that the volume change of the anode material particles can be efficiently suppressed. Also, each anode material particle used in the disclosed embodiments comprises the coat film covering the surface of the laminate to cover at least the void layers. That is, each anode material particle used in the disclosed embodiments comprises the coat film covering the surface of the laminate to cover at least the surfaces and end surfaces of the void layers, which are expected to be exposed to the outer space surrounding the anode material particles if each anode material particle used in the disclosed embodiments has no coat film. For example, as will be shown below in FIGS. 1 and 2, when viewing the cross section of the laminate along the thickness direction of the layers, the layers are arranged along a direction across the laminate. In this cross section, each anode material particle comprises the coat film covering the surface of the laminate to cover the end surfaces of the void layers disposed between the Si-based material layers and to cover the outer surface of the void layer disposed at the end of the laminate. Accordingly, the coat film functions as a support for retaining the structure of the void layers, and it is presumed that the spaces of the void layers are ensured, and the void layers can narrow when the Si-based material layers expand and can widen when the Si-based material layers contract. Accordingly, it is presumed that the structure and size of the laminate can be retained even after charge and discharge, and even if charge and discharge are repeated, the expansion and contraction of the anode material particles can be suppressed, and the expansion and contraction of the whole anode can be suppressed. In the case of using an anode mixture obtained by mixing the anode material particles and a solid electrolyte, lithium ions passes through a contact surface between the anode material particles and the solid electrolyte in the anode mix. In the anode for sulfide all-solid-state batteries according to the disclosed embodiments, the volume change of the anode material particles due to charge and discharge is suppressed, whereby a gap is less likely to be created between the anode material particles and the solid electrolyte, and contact between the anode material particles and the solid electrolyte is easily maintained. Accordingly, a decrease in lithium ion conduction is suppressed, and an increase in resistance after charge and discharge is suppressed.

Hereinafter, the anode for sulfide all-solid-state batteries according to the disclosed embodiments will be described in detail.

The anode for sulfide all-solid-state batteries according to the disclosed embodiments comprises at least the anode material particles. The anode may comprise an anode mixture containing the anode material particles, a solid electrolyte and an electroconductive material. As needed, it may further comprise an anode current collector.

The anode of the disclosed embodiments is a concept that encompasses the anode which is incorporated in the below-described sulfide all-solid-state battery and which is not initially charged yet.

Hereinafter, as an embodiment of the anode for sulfide all-solid-state batteries, the anode for sulfide all-solid-state batteries which contains the anode mixture containing the anode material particles, the solid electrolyte and the electroconductive material, will be described in detail.

FIG. 1 is a schematic enlarged cross-sectional view of an example of the anode for sulfide all-solid-state batteries according to the disclosed embodiments, and it shows an anode 30A for sulfide all-solid-state batteries before charge and a charged anode 30B for sulfide all-solid-state batteries, which is the anode 30A for sulfide all-solid-state batteries after charge. Each of the anodes 30A and 30B for sulfide all-solid-state batteries shown in FIG. 1 contains an anode mixture 20 containing an anode material particle 10, a solid electrolyte 4 and an electroconductive material (not shown). The anode material particle 10 contains: Si-based material layers 1; void layers 2; a laminate in which Si-based material layers 1 and void layers 2 are alternately laminated; and a coat film 3 covering the surface of the laminate.

FIG. 2 is a schematic enlarged cross-sectional view of another example of the anode for sulfide all-solid-state batteries according to the disclosed embodiments, and it shows an anode 30C for sulfide all-solid-state batteries before charge and a charged anode 30D for sulfide all-solid-state batteries, which is the anode 30C for sulfide all-solid-state batteries after charge. Each of the anodes 30C and 30D for sulfide all-solid-state batteries shown in FIG. 2 contains an anode mixture 20 containing an anode material particle 10, a solid electrolyte 4 and an electroconductive material (not shown). The anode material particle 10 contains: Si-based material layers 1; void layers 2; solid electrolyte material layers 4a; a laminate in which the Si-based material layers 1 and the void layers 2 are alternately laminated and on the void layer 2-side surfaces of the Si-based material layers 1, the solid electrolyte material layers 4a are disposed adjacent to the void layers 2; and a coat film 3 covering the surface of the laminate.

### <Anode Mixture>

The anode mixture contains the anode material particles, the solid electrolyte and the electroconductive material. As needed, it may further contain other components.

### (Anode Material Particles)

Each anode material particle comprises a laminate which comprises void layers and Si-based material layers containing at least one Si-based material selected from the group consisting of Si and a Si alloy, and in which the Si-based material layers and the void layers are alternately laminated, and each anode material particle comprises a coat film covering a surface of the laminate to cover at least the void layers.

The Si-based material layers contain at least one Si-based material selected from the group consisting of Si and a Si alloy. The Si alloy is not particularly limited, as long as it is an alloy of Si and a metal that is able to form an alloy with Si. As the Si alloy, examples include, but are not limited to, Si—Al-based alloy, Si—Sn-based alloy, Si—In-based alloy, Si—Ag-based alloy, Si—Pb-based alloy, Si—Sb-based alloy, Si—Bi-based alloy, Si—Mg-based alloy, Si—Ca-based alloy, Si—Ge-based alloy, Si—Pb-based alloy and Si—Cu-based alloy. For example, the Si—Al-based alloy means an alloy that contains at least Si and Al, and it may be an alloy of Si and Al or may be an alloy of Si, Al and another element. The same applies to the above-listed alloys other than the Si—Al-based alloy. The Si alloy may be a two-component alloy or a multiple-component alloy (i.e., a three-component (or more) alloy).

The Si-based material may be elemental Si, due to its high energy density.

The Si-based material layers may further contain components other than the Si-based material, as long as the effects of the disclosed embodiments are not impaired. As the other components that may be contained in the Si-based material layers, examples include, but are not limited to, a material for soluble layers that are used for the formation of the void layers described below.

In the Si-based material layers, the content of the other components than the Si-based material may be 1 mass % or less, or it may be 0.5 mass % or less, from the viewpoint of increasing energy density.

Each anode material particle comprises a laminate in which the Si-based material layers and the void layers are alternately laminated. The void layers are spaces surrounded by the Si-based material layers (or other layers such as a solid electrolyte layer described below) and the below-described coat film.

The layers of the laminate are not particularly limited, as long as they are in a layer form. For efficient reaction with Li, the layers may be in a continuous layer form having no break. For the laminate, as shown in FIGS. 1 and 2, in the cross section of the laminate along the thickness direction of the layers, the layers may be arranged along a direction across the laminate, from the point of view that it is easy to suppress the expansion of the anode material particles. Especially, from the point of view that it is easy to suppress the expansion of the anode material particles and to produce the anode material particles, the layers of the laminate may be in a flat plate form having a uniform thickness. The “uniform thickness” means that layer thickness variation may be 5% or less of the average thickness.

The internal structure of each anode material particle and the form and thickness of the layers can be checked on a scanning electron microscope (SEM) image of a cross section of the anode material particle.

The thickness of each Si-based material layer may be 50 nm or more, may be 60 nm or more, or may be 80 nm or more, from the point of view that it is easy to form the Si-based material layers having a uniform thickness.

On the other hand, the thickness of each Si-based material layer may be 500 nm or less, or it may be 453 nm or less, from the point of view that the structure of the laminate is easily retained after charge and discharge, and it is highly effective in suppressing the expansion of the Si-based material layers in the plane direction and in suppressing the volume change of the anode material particles. The thickness of each Si-based material layer is the average of the thicknesses of randomly selected 5 points of each Si-based material layer.

The variation in the thickness of the Si-based material layers in the laminate, is not particularly limited. From the viewpoint of efficiently suppressing the expansion of the anode material particles, each of the difference between the maximum thickness and the average thickness of the Si-based material layers in the laminate, and the difference between the minimum thickness and the average thickness, may be 15% or less of the average thickness.

In the disclosed embodiments, the average thickness of the Si-based material layers is obtained as follows: the thickness of each Si-based material layer is determined as the average of the thicknesses of randomly selected 5 points of each Si-based material layer; the thicknesses of three Si-based material layers randomly selected from the Si-based material layers of each anode material particle, are obtained; and the average of the thicknesses of the three Si-based material layers is determined as the average thickness of the Si-based material layers of each anode material particle.

The thickness of each void layer may be 10% or more of the average thickness of the Si-based material layers, or it may be 30% or more of the average thickness of the Si-based material layers, from the point of view that the structure of the laminate is easily retained after charge and discharge, and it is highly effective in suppressing the volume change of the anode material particles. On the other hand, from the viewpoint of increasing energy density, the thickness of each void layer may be 150% or less of the average thickness of the Si-based material layers, or it may be 132% or less of the average thickness of the Si-based material layers.

The thickness of each void layer may be appropriately determined depending on the thickness of each Si-based material layer, and it is not particularly limited. For example, the thickness may be in a range of from 5 nm to 500 nm. From the point of view that the structure of the laminate is easily retained after charge and discharge, and it is highly effective in suppressing the expansion of the volume change of the anode material particles, the thickness of each void layer may be 8 nm or more, or it may be 30 nm or more. On the other hand, from the viewpoint of increasing energy density, the thickness of each void layer may be 350 nm or less, or it may be 338 nm or less.

The variation in the thickness of the void layer in the laminate, is not particularly limited. From the viewpoint of efficiently suppressing the expansion of the anode material particles, each of the difference between the maximum thickness and the average thickness of the void layers in the laminate, and the difference between the minimum thickness and the average thickness, may be 15% or less of the average thickness. In the disclosed embodiments, the thickness of each void layer is determined as the average of the thicknesses of randomly selected 5 points of each void layer. The average thickness of the void layers can be obtained in the same manner as the average thickness of the Si-based material layers.

In addition to the Si-based material layers and the void layers, each anode material particle may further comprise other layers such as solid electrolyte material layers. From the viewpoint of increasing lithium ion conduction to the Si-based material layers and suppressing an increase in resistance after charge and discharge, each anode material particle may further comprise solid electrolyte material layers containing a solid electrolyte material. When each anode material particle comprises the solid electrolyte material layers, on the void layer-side surfaces of the Si-based material layers of the laminate of each anode material particle, the solid electrolyte material layers may be disposed adjacent to the void layers, from the point of view that the contact area between the Si-based material layers and the solid electrolyte material is increased, thereby increasing the lithium ion conduction to the Si-based material layers and suppressing an increase in resistance after charge and discharge.

The solid electrolyte material contained in the solid electrolyte material layers is not particularly limited, as long as it is a material that is applicable to a solid electrolyte layer disposed between the cathode and anode of a sulfide all-solid-state battery. As the solid electrolyte material, examples include, but are not limited to, the same sulfide-based solid electrolytes as those that is applicable to the below-described solid electrolyte layer. When each anode material particle comprises the solid electrolyte material layers, the solid electrolyte material contained in the solid electrolyte material layers may be the same as or different from the solid electrolyte contained in the below-described anode mixture.

As needed, the solid electrolyte material layers may further contain components other than the solid electrolyte material, as long as the effects of the disclosed embodiments are not impaired. As the other components that may be contained in the solid electrolyte material layers, examples include, but are not limited to, an electroconductive material and the same other components as those that may be contained in the below-described anode mixture.

When each anode material particle comprises the solid electrolyte material layers, the thickness of each solid electrolyte material layer in the laminate may be 10% or more of the average thickness of the Si-based material layers, or it may be 11% or more of the average thickness, from the point of view that lithium ion conduction to the Si-based material layers is excellent, and it is easy to maintain contact between the Si-based material layers and the solid electrolyte material layers after charge and discharge, whereby an increase in resistance after charge and discharge is easily suppressed. On the other hand, from the viewpoint of increasing energy density, the thickness of each solid electrolyte material layer in the laminate may be 50% or less, may be 40% or less, or may be 37% or less. In the disclosed embodiments, the thickness of each solid electrolyte material layer is determined as the average of the thicknesses of randomly selected 5 points of each solid electrolyte material layer.

Also, the thickness of each solid electrolyte material layer may be appropriately determined depending on the thickness of each Si-based material layer, and it is not particularly limited. For example, the thickness may be in a range of from 10 nm to 150 nm. From the point of view that an increase in resistance after charge and discharge is easily suppressed, the thickness of each solid electrolyte material layer may be in a range of from 12 nm to 114 nm.

Also, when each anode material particle comprises the solid electrolyte material layers, the thickness of each void layer in the laminate may be 100% or more of the average thickness of the Si-based material layers. When the Si-based material layers expands during charge and, as a result, the solid electrolyte material layers are brought into contact with each other, the solid electrolyte material layers easily attach to each other. When the Si-based material layers contract during discharge, the solid electrolyte material layers are peeled off from the Si-based material layers to decrease the contact area between the Si-based material layers and the solid electrolyte material. Accordingly, lithium ion conduction to the Si-based material layers is not increased, and it may be difficult to suppress an increase in resistance. On the other hand, when the thickness of each void layer is 100% or more of the average thickness of the Si-based material layers, the contact between the solid electrolyte material layers can be suppressed during charge, and it is easy to maintain the contact between the Si-based material layers and the solid electrolyte material layers after charge and discharge, and an increase in resistance is easily suppressed. The thickness of each void layer may be 104% or more of the average thickness of the Si-based material layers. When each anode material particle comprises the solid electrolyte material layers, the thickness of each void layer in the laminate is not particularly limited. From the viewpoint of increasing energy density, the thickness of each void layer may be 150% or less of the average thickness of the Si-based material layers, or it may be 132% or less of the average thickness of the Si-based material layers.

Also, when each anode material particle comprises the solid electrolyte material layers, the thickness of each Si-based material layer in the laminate may be in a range of from 60 nm to 316 nm, from the viewpoint of energy density and from the viewpoint of suppressing the expansion and contraction of the anode material particles and, as a result, suppressing an increase in resistance after charge and discharge.

Each anode material particle comprises the coat film covering the surface of the laminate to cover at least the void layers. That is, each anode material particle comprises the coat film covering the surface of the laminate to cover at least the surfaces and end surfaces of the void layers, which are expected to be exposed to the outer space surrounding the anode material particles if each anode material particle has no coat film. Accordingly, in the laminate, the spaces of the void layers are ensured, and the structure and size of the laminate can be retained even after charge and discharge. As used herein, “to cover the void layers” means that the void layers are substantially covered. As long as the effects of the disclosed embodiments are not impaired, the coat film may have a minute defect such as a hole having a diameter that is 10% or less of the thickness of each void layer.

The coverage of the coat film on the laminate is appropriately determined to cover at least the void layers, and it is not particularly limited. The coverage may be 70% or more, or it may be 80% or more, from the point of view that the structure of the laminate is easily retained, and it is highly effective in suppressing the volume change of the anode material particles. On the other hand, from the viewpoint of lithium ion conductivity, the coverage may be 95% or less. For example, when the coat film encompasses the laminate and has such a minute effect that can retain the structure and size of the laminate, the coverage may be 70% or more and less than 100%.

The coverage of the coat film can be obtained as follows: the area of the whole surface of each anode material particle having the coat film on its outermost surface, is determined as 100%, and the coverage of the coat film is obtained as the percentage of the area of the coat film on the particle surface with respect to the area of the whole particle surface.

Also, the coverage of the coat film can be measured by a transmission electron microscope (TEM) and X-ray photoelectron spectroscopy (XPS), for example.

The material for the coat film may be a material that can conduct lithium ions and electrons. For example, a carbonaceous material may be used. The carbonaceous material is not particularly limited, as long as it contains at least carbon. As the carbonaceous material, examples include, but are not limited to, graphite, mesocarbon microbeads (MCMB), highly oriented pyrolytic graphite (HOPG), hard carbon, soft carbon and carbon blacks (e.g., acetylene black and Ketjen Black).

The thickness of the coat film is not particularly limited. The thickness of the coat film may be 20 nm or more, or it may be 30 nm or more, from the point of view that the inner structure of the anode material particles is easily retained. On the other hand, from the viewpoint of increasing energy density, the thickness of the coat film may be 100 nm or less, or it may be 80 nm or less.

The size of each anode material particle is not particularly limited. From the point of view that the inner structure of the anode material particles is easily retained, the size of each anode material particle may be such that the median diameter (D50) of the anode material particles is 2 μm or more, or it is 5 μm or more. On the other hand, the median diameter (D50) of the anode material particles may be 20.5 μm or less, from the point of view that an increase in pressure to a confining jig, which is due to the expansion of the anode material particles, and an increase in resistance are easily suppressed.

The median diameter (D50) is a particle diameter corresponding to a cumulative frequency of 50 volume % from the fine particle side (small particle diameter side) of the volume-based particle size distribution of the particles measured by a laser diffraction/scattering method.

The content of the anode material particles in the anode mixture is not particularly limited. From the viewpoint of increasing energy density, the content of the anode material particles may be 30 parts by mass or more, or it may be 40 parts by mass or more, with respect to 100 parts by mass of the anode mixture. On the other hand, from the viewpoint of incorporating sufficient amounts of other materials (e.g., the solid electrolyte) in the anode mixture, the content of the anode material particles may be 90 parts by mass or less, or it may be 80 parts by mass or less.

The method for producing the anode material particles is not particularly limited. As the production method, examples include the following first and second production methods: the first production method for producing the anode material particles in each of which the laminate is composed of the Si-based material layers and the void layers are produced, and the second production method for producing the anode material particles in each of which the laminate is composed of the Si-based material layers, the void layers and the solid electrolyte material layers.

As the first production method for producing the anode material particles in each of which the laminate is composed of the Si-based material layers and the void layers, examples include, but are not limited to, a method comprising the steps of (1) forming a laminate by alternately forming soluble layers and the Si-based material layers on a support, (2) obtaining a powder by removing the laminate from the support and pulverizing the laminate, (3) forming the coat film on the surface of each of the particles of the powder to cover at least the soluble layers, and (4) forming the void layers by dissolving the soluble layers for removal after forming the coat film.

As the second production method for producing the anode material particles in each of which the laminate is composed of the Si-based material layers, the void layers and the solid electrolyte material layers, examples include, but are not limited to, a method comprising the steps of (1) forming a laminate by alternately forming the soluble layers and the Si-based material layers on a support, (2) obtaining the powder by removing the laminate from the support and pulverizing the laminate, (3) forming the coat film on the surface of each powder particle to cover at least the soluble layers, (4) forming the void layers by dissolving the soluble layers for removal after forming the coat film, and (5) forming the solid electrolyte material layers on the void layer-side surfaces of the Si-based material layers.

The support used in the first and second production methods is not particularly limited. For example, a resin film such as a polyimide film can be used. The support may have a carbon film on a surface thereof. The carbon film can be formed by, for example, carbon sputtering on the support.

In the laminate forming step of the first and second production method, the layers formed first may be the soluble layers or the Si-based material layers, and the layers formed last may be the soluble layers or the Si-based material layers.

In the laminate forming step, the method for forming the soluble layers and the method for forming the Si-based material layers are not particularly limited. As the methods, examples include, but are not limited to, a sputtering method and a deposition method such as chemical vapor deposition (CVD). From the viewpoint of easy control of film thickness, the sputtering method may be used.

As the soluble layers, examples include, but are not limited to, layers soluble in hydrofluoric acid such as SiO₂ layers. The method for forming the soluble layers is not particularly limited. For example, the SiO₂ layers can be formed by a reactive sputtering method under an oxygen gas atmosphere, in which a Si-containing material is determined as a sputtering target. Spaces are formed by dissolving the soluble layers for removal, and since the thus-formed spaces serve as the void layers, the thickness of the void layers in each anode material particle can be controlled by controlling the thickness of the soluble layers in the laminate forming step.

The Si-based material layers formed in the laminate forming step may contain at least one Si-based material selected from the group consisting of Si and a Si alloy. From the viewpoint of increasing energy density, the content of components other than the Si-based material in the Si-based material layers may be zero. As the Si-based material, examples include, but are not limited to, the same materials as those described above.

The method for removing the laminate from the support is not particularly limited. The method for pulverizing the laminate is not particularly limited. For example, the laminate pulverizing method may be a method by which the diameters of the powder particles can be easily rendered uniform, such as the following method: the laminate is roughly pulverized in an agate mortar, and then the roughly pulverized laminate is further pulverized with a jet mill.

The method for forming the coat film on the surface of each powder particle to cover at least the soluble layers, is not particularly limited. As the method for forming the coat film composed of the carbonaceous material (hereinafter it may be referred to as “carbon coat film”), examples include, but are not limited to, the following method: the powder is immersed in a resorcinol-formalin solution and then sintered in an inert atmosphere. By this method, the coverage of the coat film can be readily controlled to 70% or more. In this method, the thickness of the carbon coat film can be controlled by the concentration of the resorcinol-formalin solution.

The method for forming the void layers by dissolving the soluble layers for removal after forming the coat film, is appropriately selected depending on the material for the soluble layer, and it is not particularly limited. When the soluble layers are SiO₂ layers, the powder is immersed in hydrofluoric acid after forming the coat film, thereby dissolving the SiO₂ layers for removal. The conditions of the method (such as the concentration of the hydrofluoric acid, the powder immersing time, and the amount of the powder immersed in the hydrofluoric acid) are appropriately determined to dissolve the SiO₂ layers for removal, and they are not particularly limited.

After the void layer forming step, the first production method may further include the step of drying the solvent remaining inside the anode material particles.

In the second production method, the method for forming the solid electrolyte material layers containing the solid electrolyte material on the void layer-side surfaces of the Si-based material layers, is not particularly limited. As the solid electrolyte material layer forming method, examples include, but are not limited to, the following method: after the void layer is formed, the powder is immersed in a solution containing the solid electrolyte material and a solvent, and then the solvent is dried for removal.

The solvent used in the solution containing the solid electrolyte material and the solvent, may be a solvent which can dissolve or disperse the solid electrolyte material and the above-described other components added as needed, and which can permeate the coat film. The solvent can be appropriately selected from known solvents. For example, the solvent may be ethanol.

For the solution containing the solid electrolyte material and the solvent, the components other than the solvent are the same as those contained in the solid electrolyte material layers.

The solid content concentration of the solution containing the solid electrolyte material and the solvent, may be 3 mass % or more and 15 mass % or less, or it may be 4 mass % or more and 10 mass % or less, from the point of view that the solution can easily wet and spread on the surface of the Si-based material layers, and it is easy to control the thickness of the solid electrolyte material layers. The thickness of each solid electrolyte material layer can be controlled by the solid content concentration of the solution containing the solid electrolyte material and the solvent. The thickness of each solid electrolyte material layer can be increased by increasing the solid content concentration. In the disclosed embodiments, “solid content” means all components other than solvents.

Conditions such as the powder immersion time (the time taken for immersing the powder in the solution containing the solid electrolyte material and the solvent after forming the void layer) and the amount of the powder put in the solution, are appropriately determined to ensure that the solution will wet and spread on the surface of the Si-based material layers, and they are not particularly limited.

After the solid electrolyte material layer forming step, the second production method may further include the step of drying the solvent remaining inside the anode material particles for removal.

### (Solid Electrolyte)

The raw material for the solid electrolyte used in the anode mixture is not particularly limited, as long as it is a raw material that is applicable to the solid electrolyte layer disposed between the cathode and anode of the sulfide all-solid-state battery. As the raw material, examples include, but are not limited to, the same sulfide-based solid electrolytes as those that are applicable to the below-described solid electrolyte layer.

The content of the solid electrolyte in the anode mixture is not particularly limited. From the viewpoint of increasing lithium ion conductivity, the content of the solid electrolyte may be 10 parts by mass or more, or it may be 20 parts by mass or more, with respect to 100 parts by mass of the anode mixture. On the other hand, from the viewpoint of incorporating sufficient amounts of other materials (e.g., the anode material particles) in the anode mixture, the content of the solid electrolyte may be 80 parts by mass or less, or it may be 70 parts by mass or less.

### (Electroconductive Material)

The electroconductive material is not particularly limited, as long as it is an electroconductive material that is applicable to an all-solid-state battery. As the electroconductive material, examples include, but are not limited to, a carbonaceous material. As the carbonaceous material used as the electroconductive material, examples include, but are not limited to, at least one carbonaceous material selected from the group consisting of carbon black (e.g., acetylene black and furnace black), carbon nanotube and carbon nanofiber. From the viewpoint of electron conductivity, the electroconductive material may be at least one carbonaceous material selected from the group consisting of carbon nanotube and carbon nanofiber. The carbon nanotube and carbon nanofiber may be vapor-grown carbon fiber (VGCF).

With respect to 100 parts by mass of the anode mixture, the content of the electroconductive material in the anode mixture may be 1.0 part by mass or more, from the point of view that many electron conducting paths can be ensured in the anode. On the other hand, the content of the electroconductive material in the anode mixture may be 15 parts by mass or less, from the viewpoint of incorporating sufficient amounts of other materials (e.g., the anode material particles and the solid electrolyte) in the anode mixture.

### (Other Components of the Anode Mixture)

In addition to the above-described components, the anode mixture may contain other components such as a binder.

As the binder, examples include, but are not limited to, polyvinylidene fluoride (PVDF), polytetrafluoroethylene (PTFE), butylene rubber (BR), styrene-butadiene rubber (SBR), polyvinyl butyral (PVB) and acrylic resin.

The content of the binder in the anode mixture is not particularly limited. With respect to 100 parts by mass of the anode mixture, the content of the binder may be 0.3 part by mass or more, or it may be 0.5 part by mass or more, from the viewpoint of allowing the binder to function sufficiently. On the other hand, the content of the binder may be 5 parts by mass or less, from the viewpoint of incorporating sufficient amounts of other materials (e.g., the anode material particles and the solid electrolyte) in the anode mixture.

The form of the anode mixture is not particularly limited. For example, the anode mixture may be in a layer form.

When the anode mixture is in a layer form, the thickness of the anode mixture is not particularly limited. For example, it may be 10 μm or more and 100 μm or less, or it may be 10 μm or more and 50 μm or less.

### (Method for Producing the Anode Mixture)

The method for producing the anode mixture is not particularly limited. As the method, examples include, but are not limited to, a method of compression-forming a powder or pellets of the raw material for the anode mixture, and a method of applying a slurry of the raw material for the anode mixture and drying the applied slurry.

The raw material for the anode mixture may contain the anode material particles, the electroconductive material, the solid electrolyte, and other components incorporated as needed (e.g., the binder). In addition, the raw material for the anode mixture may contain components that are removed in the process of producing the anode mixture. As the components that are contained in the raw material for the anode mixture, removed in the process of producing the anode mixture and then not contained in the anode mixture, examples include, but are not limited to, a solvent and a removable binder. As the removable binder, such a binder can be used, that functions as the binder in the production of the anode mixture and is decomposed or volatilized and removed by sintering in the step of obtaining the anode mixture. By producing the anode mixture with the use of the removable binder, the content of the binder in the anode mixture can be decreased.

The method for preparing the raw material for the anode mixture is not particularly limited. For example, the slurry of the raw material for the anode mixture can be obtained by stirring a mixture of the anode material particles, the electroconductive material, the solid electrolyte, other components incorporated as needed (e.g., the binder) and a solvent, with an ultrasonic disperser, a stirrer or the like.

The solvent used in the slurry of the raw material for the anode mixture, is not particularly limited. As the solvent, examples include, but are not limited to, heptane, butyl butyrate, alcohols (such as methanol, ethanol, propanol and propylene glycol), N,N-dimethylformamide, N,N-diethylformamide, N,N-dimethylacetamide, N,N-diethylacetamide, mixtures thereof and mixtures thereof with water.

The method for dispersing the components in the slurry of the raw material for the anode mixture, is not particularly limited. As the dispersion method, examples include, but are not limited to, a homogenizer, a bead mill, a shear mixer and a roll mill.

The pellets of the raw material for the anode mixture can be obtained by drying the slurry of the raw material for the anode mixture, weighing out a predetermined amount of the dried slurry, and compression-forming the dried slurry.

In the case of producing the anode mixture by compression-forming the powder or pellets of the raw material for the anode mixture, the compression-forming pressure is not particularly limited. For example, it may be 20 MPa or more and 1000 MPa or less.

In the case of producing the anode mixture by use of the slurry of the raw material for the anode mixture, the anode mixture can be obtained by, for example, applying the slurry of the raw material for the anode mixture on the below-described solid electrolyte layer or on another support and drying the applied slurry.

The method for applying the slurry of the raw material for the anode mixture may be a known method and is not particularly limited. As the applying method, examples include, but are not limited to, a spraying method, a screen printing method, a doctor blade method, a gravure printing method and a die coating method.

The method for drying the slurry of the raw material for the anode mixture may be a known method and is not particularly limited. As the drying method, examples include, but are not limited to, drying under reduced pressure, heat drying, and heat drying under reduced pressure. The drying condition is not particularly limited and may be appropriately determined.

When the raw material for the anode mixture contains the removable binder, the raw material may be sintered for removal of the binder.

### <Anode Current Collector>

The anode current collector functions to collect current from the anode mixture.

As the material for the anode current collector, examples include, but are not limited to, Cu and a Cu alloy. A coating layer of Ni, Cr, C or the like may be formed on the surface of the anode current collector. The coating layer may be a plating layer or a deposition layer, for example.

As the form of the anode current collector, examples include, but are not limited to, a foil form, a plate form and a mesh form.

The anode for sulfide all-solid-state batteries according to the disclosed embodiments may further include an anode lead that is connected to the anode current collector.

<Method for Producing the Anode for Sulfide all-Solid-State Batteries>

The method for producing the anode for sulfide all-solid-state batteries according to the disclosed embodiments, is not particularly limited. When the anode for sulfide all-solid-state batteries according to the disclosed embodiments is composed of the anode mixture, the anode for sulfide all-solid-state batteries according to the disclosed embodiments can be produced by, for example, the same method as the above-described anode mixture production method. When the anode for sulfide all-solid-state batteries according to the disclosed embodiments comprises the anode mixture and the anode current collector, the anode for sulfide all-solid-state batteries according to the disclosed embodiments can be obtained by, for example, forming the anode mixture on the anode current collector by the above-described anode mixture production method. Also, the anode for sulfide all-solid-state batteries according to the disclosed embodiments can be obtained by obtaining the anode mixture by the above-described anode mixture production method and then disposing the anode current collector on at least part of the anode mixture surface.

2. Sulfide all-Solid-State Battery

The sulfide all-solid-state battery of the disclosed embodiments is a sulfide all-solid-state battery comprising the above-described anode for sulfide all-solid-state batteries.

The sulfide all-solid-state battery of the disclosed embodiments is a concept that encompasses the sulfide all-solid-state battery which is not initially charged yet.

The sulfide all-solid-state battery of the disclosed embodiments comprises the anode for sulfide all-solid-state batteries. Accordingly, the expansion and contraction of the anode during charge is suppressed, and the expansion of the battery itself can be suppressed during charge.

The sulfide all-solid-state battery of the disclosed embodiments comprises the anode for sulfide all-solid-state batteries. It may further comprise other components that are generally disposed in sulfide all-solid-state batteries.

FIG. 3 is a schematic sectional view of an example of the sulfide all-solid-state battery according to the disclosed embodiments. A sulfide all-solid-state battery 100 shown in FIG. 3 includes a cathode 16, an anode 17 and a solid electrolyte layer 11. The cathode 16 includes a cathode mixture 12 and a cathode current collector 14. The anode 17 includes an anode mixture 13 and an anode current collector 15. The solid electrolyte layer 11 is disposed between the cathode 16 and the anode 17. The anode 17 is the anode for sulfide all-solid-state batteries according to the disclosed embodiments.

Single cells as shown in FIG. 3 may be stacked and electrically connected to form a cell assembly, and the cell assembly may be used as the sulfide all-solid-state battery of the disclosed embodiments.

The sulfide all-solid-state battery of the disclosed embodiments may be used in such a state that confining pressure is applied thereto by a confining jig (not shown). Since the sulfide all-solid-state battery of the disclosed embodiments is such a battery that is suppressed from expansion during charge, it is easy to design the confining jig, and it is possible to use a confining jig that has smaller strength than conventional all-solid-state batteries comprising a Si-based anode active material.

### <Anode>

The anode of the sulfide all-solid-state battery of the disclosed embodiments will not be described here, since it is the same as the above-described anode for sulfide all-solid-state batteries according to the disclosed embodiments.

### <Cathode>

The cathode comprises at least the cathode mixture. As needed, it may further include the cathode current collector.

The cathode mixture contains at least a cathode active material. As needed, it may contain an electroconductive material, a binder, a solid electrolyte, etc.

As the cathode active material, conventionally known materials may be used. As the cathode active material, examples include, but are not limited to, lithium cobaltate (LiCoO₂), lithium nickelate (LiNiO₂), lithium nickel cobalt aluminate (such as LiNi_{0.8}Co_{0.15}Al_{0.05}O₂), lithium nickel cobalt manganate (such as LiNi_{3/5}Mn_{1/5}Co_{1/5}O₂ and Li₁₊ₓNi_{1/3}Mn_{1/3}Co_{1/3}O₂ (0≤x<0.3)), lithium manganate (LiMn₂O₄), different element-substituted Li—Mn spinels represented by the composition formula Li₁₊ₓMn_{2-x-y}M_{y}O₄ (where M is at least one element selected from the group consisting of Al, Mg, Co, Fe, Ni and Zn; 0≤x<0.5; and 0≤y<2), lithium titanate and lithium metal phosphate (LiMPO₄, M=Fe, Mn, Co, Ni).

The form of the cathode active material is not particularly limited. As the form, examples include, but are not limited to, a particulate form and a film form.

A coating layer composed of a Li ion conducting oxide may be formed on the surface of the cathode active material. This is because a reaction between the cathode active material and the solid electrolyte can be suppressed.

As the Li ion conducting oxide, examples include, but are not limited to, LiNbO₃, Li₄Ti₅O₁₂ and Li₃PO₄. The thickness of the coating layer of the Li ion conducting oxide is not particularly limited. For example, the thickness may be in a range of from 0.1 nm to 100 nm, or it may be in a range of from 1 nm to 20 nm. The coverage of the coating layer of the Li ion conducting oxide on the cathode active material surface, may be 50% or more, or it may be 80% or more, from the viewpoint of suppressing a reaction between the cathode active material and the solid electrolyte.

As the electroconductive material, binder and solid electrolyte used in the cathode mixture, the same materials as those used in the above-described anode mixture, may be used.

When the cathode mixture is in a layer form, the thickness of the cathode mixture is not particularly limited. For example, the thickness may be 10 μm or more and 250 μm or less, or it may be 20 μm or more and 200 μm or less.

The method for producing the cathode mixture is not particularly limited. As the method, examples include, but are not limited to, a method of compression-forming a powder or pellets of the raw material for the cathode mixture, the raw material containing at least the cathode active material, and a method of applying a slurry of the raw material for the cathode mixture, the raw material containing at least the cathode active material and a solvent, and drying the applied slurry. More specifically, the same method as the above-described anode mixture production method can be used.

The cathode current collector functions to collect current from the cathode mixture.

As the material for the cathode current collector, examples include, but are not limited to, SUS, Ni, Cr, Au, Pt, Al, Fe, Ti and Zn. A coating layer composed of Ni, Cr, C or the like may be formed on the surface of the cathode current collector. The coating layer may be a plating layer or a deposition layer, for example.

The form of the cathode current collector may be the same as the above-described form of the anode current collector.

The cathode may further include a cathode lead that is connected to the cathode current collector.

### <Solid Electrolyte Layer>

The solid electrolyte layer contains at least a sulfide-based solid electrolyte. As needed, it may contain a binder, etc.

As the sulfide-based solid electrolyte contained in the solid electrolyte layer, examples include, but are not limited to, Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and Z is any one of Ge, Zn and Ga), Li₂S—GeS₂, Li₂S—SiS₂—Li₃PO₄, and Li₂S—SiS₂—LiₓMO_{y} (where x and y are positive numbers, and M is any one of P, Si, Ge, B, Al, Ga and In). The sulfide-based solid electrolyte “Li₂S—P₂S₅” means a sulfide solid electrolyte material composed of a raw material composition containing Li₂S and P₂S₅. The same applies to other sulfide-based solid electrolytes.

The form of the solid electrolyte layer is not particularly limited. As the form, examples include, but are not limited to, a particulate form and a film form.

As the binder that may be contained in the solid electrolyte layer, examples include, but are not limited to, the same binders as those that may be contained in the above-described anode mixture.

The content of the sulfide-based solid electrolyte in the solid electrolyte layer is not particularly limited. For example, it may be 50 mass % or more, may be in a range of from 70 mass % to 99.99 mass %, or may be in a range of from 90 mass % to 99.9 mass %.

The method for forming the solid electrolyte layer is not particularly limited. As the method, examples include, but are not limited to, a method of compression-forming a powder or pellets of the raw material for the solid electrolyte layers, the raw material containing at least the sulfide-based solid electrolyte. The method and condition of the compression forming may be the same as those of the above-described case of compression-forming the powder or pellets of the raw material for the anode mixture.

Also, the solid electrolyte layer can be formed by applying a slurry of the raw material for the solid electrolyte layers on a support, the raw material containing at least the sulfide-based solid electrolyte and a solvent, and drying the applied slurry.

### <Other Components of the Battery>

As needed, the sulfide all-solid-state battery of the disclosed embodiments may include an outer casing for housing the cathode, the anode and the solid electrolyte layer.

The form of the outer casing is not particularly limited. As the form, examples include, but are not limited to, a laminate form.

The material for the outer casing is not particularly limited, as long as it is a material that is stable in electrolytes. As the material, examples include, but are not limited to, resins such as polypropylene, polyethylene and acrylic resins.

As the form of the sulfide all-solid-state battery of the disclosed embodiments, examples include, but are not limited to, a coin form, a laminate form, a cylindrical form and a square form.

In general, the sulfide all-solid-state battery of the disclosed embodiments is used in such a state that confining pressure is applied thereto by a confining jig. The confining jig is not particularly limited. For example, the confining jig includes a pressure applying section for applying confining pressure to the sulfide all-solid-state battery (such as a confining plate) and a pressure controlling section for controlling the confining pressure.

The sulfide all-solid-state battery of the disclosed embodiments is typically a lithium ion battery. The sulfide all-solid-state battery may be a primary battery or a secondary battery. The sulfide all-solid-state battery may be a secondary battery, from the point of view that a secondary can be repeatedly charged and discharged, and it is useful as a car battery, for example. The primary battery encompasses the case of using a secondary battery as a primary battery (the case of using a charged secondary battery for the purpose of one-time discharge).

<Method for Producing the Sulfide all-Solid-State Battery>

The method for producing the sulfide all-solid-state battery of the disclosed embodiments is not particularly limited, as long as it is a method by which the above-described sulfide all-solid-state battery of the disclosed embodiments can be produced. The sulfide all-solid-state battery production method may be a method in which the above-described anode mixture, cathode mixture and solid electrolyte layer are formed by compression forming, from the point of view that it is easy to increase the performance of the all-solid-state battery. As such a sulfide all-solid-state battery production method, examples include, but are not limited to, a production method comprising the steps of (1) forming the solid electrolyte layer by filling a mold in a desired form with the powder or pellets of the raw material for the solid electrolyte layers and compression-forming the powder or pellets in the mold, (2) forming the cathode mixture by filling one surface of the thus-formed solid electrolyte layer in the mold with the powder or pellets of the raw material for the cathode mixture and compression-forming the powder or pellets, and (3) forming the anode mixture by filling the other surface of the thus-formed solid electrolyte layer in the mold with the powder or pellets of the raw material for the anode mixture and compression-forming the powder or pellets. Or, the sulfide all-solid-state battery may be produced by forming a powder layer of the raw material for the cathode mixture, a powder layer of the raw material for the solid electrolyte layers, and a powder layer raw material for the anode mixture in this order in a mold in a desired form to obtain a powder deposit, and compression-forming the powder deposit at once. Or, the sulfide all-solid-state battery may be produced by separately producing the above-described anode mixture, cathode mixture and solid electrolyte layer by compression forming, and then assembling them.

Also, the sulfide all-solid-state battery of the disclosed embodiments may be produced by the following method: the above-described anode mixture, cathode mixture and solid electrolyte layer are formed by applying raw material slurries and drying the applied slurries.

### EXAMPLES

### Production Example 1: Production of a Solid Electrolyte Material

Li₂S (manufactured by Nippon Chemical Industrial Co., Ltd.) and P₂S₅ (manufactured by Aldrich) were used as starting materials. In particular, 0.7656 g of the Li₂S and 1.2344 g of the P₂S₅ were weighed out and mixed in an agate mortar for 5 minutes to obtain a mixture. Next, 4 g of heptane was added to the mixture. The mixture was subjected to mechanical milling for 40 hours with a planetary ball mill, thereby obtaining a powder of a solid electrolyte material (Li₂S—P₂S₅).

### Example 1

### <Production of Anode Material Particles>

A support was obtained by forming a carbon coat film on one surface of a polyimide film by carbon sputtering. A SiO₂ layer having a thickness of 30 nm was formed on the carbon coat film-side surface of the support, by a reactive sputtering method under an oxygen gas atmosphere, in which Si was determined as a sputtering target. In addition, a Si layer having a thickness of 80 nm was formed on the SiO₂ layer by Si sputtering under a vacuum atmosphere. Then, the formation of the SiO₂ layer having a thickness of 30 nm and the formation of the Si layer having a thickness of 80 nm, were repeated on the support to form a laminate of 500 layers in which the SiO₂ layers and the Si layers were alternately laminated.

The laminate was removed from the support. The removed laminate was roughly pulverized in an agate mortar for 30 minutes. Then, the roughly pulverized laminate was further pulverized with a jet mill, thereby obtaining a powder of the laminate. The powder was classified to ensure that the median diameter (D50) of anode material particles would be 5 μm. The thus-obtained powder was immersed in a resorcinol-formalin solution and then sintered at 820° C. for two hours under an Ar atmosphere, thereby covering the surface of each of the particles of the powder of the laminate with a carbon coat film. Then, the powder was immersed in hydrofluoric acid (concentration 5 mass %) to dissolve the SiO₂ layers of the powder particles for removal, thereby forming void layers. As a result, anode material particles (1) were obtained.

For the anode material particles, a SEM image of the cross-sections of the particles was taken. The inner structure of the anode material particles and the thicknesses of the layers of the anode material particles, were checked by the SEM image of the cross sections of the anode material particles. As a result, it was found that each anode material particle (1) comprises a laminate which comprises Si-based material layers each having a thickness of 80 nm (the Si-based material layers were Si layers) and void layers each having a thickness of 30 nm and in which the Si-based material layers and the void layers are alternately laminated, and each anode material particle (1) comprises a coat film having a thickness of 80 nm and covering the surface of the laminate to cover at least the void layers (the coat film was a carbon coat film).

For the anode material particles, a TEM image of the surfaces of the particles was taken. The coverage of the coat film on the anode material particles was measured by the TEM image and X-ray photoelectron spectroscopy (XPS). The volume-based particle size distribution of the obtained anode material particles was measured by a laser diffraction/scattering particle size distribution analyzer. From the particle size distribution, the median diameter (D50) of the anode material particles was calculated.

<Production of an Anode for Sulfide all-Solid-State Batteries>

A slurry, which was a raw material for an anode mixture, was obtained by mixing 5.0 mg of the above-obtained anode material particles, 4.0 mg of the solid electrolyte material obtained in Production Example 1, 0.6 mg of an electroconductive material (VGCF manufactured by Showa Denko K. K.) and 3.2 mg of a binder solution obtained by dissolving a binder in an organic solvent at a concentration of 5 mass %, the binder containing 75 mol % of PVDF.

Using an applicator, the slurry (the raw material for the anode mixture) was applied on one surface of an anode current collector (a copper foil) by a blade method. The applied slurry was dried at 100° C. for 30 minutes to form the anode mixture on the anode current collector, thereby obtaining the anode for sulfide all-solid-state batteries.

<Production of a Sulfide all-Solid-State Battery>

A slurry, which was a raw material for an anode mixture, was produced in the same manner as the above-described “Production of an anode for sulfide all-solid-state batteries” and dried. A predetermined amount of the dried slurry was weighed out and subjected to compression forming, thereby producing anode mixture pellets.

As a cathode active material, lithium nickel cobalt manganate (LiNi_{3/5}Co_{1/5}Mn_{1/5}O₂) surface-treated with LiNbO₃, was used. A slurry, which was a raw material for a cathode mixture, was obtained by mixing 24.0 mg of the cathode active material, 6.0 mg of the solid electrolyte material obtained in Production Example 1, 0.9 mg of an electroconductive material (VGCF manufactured by Showa Denko K. K.) and 2.8 mg of a binder solution obtained by dissolving a binder in an organic solvent at a concentration of 5 mass %, the binder containing 75 mol % of PVDF.

The obtained slurry (the raw material for the cathode mixture) was dried. A predetermined amount of the dried slurry was weighed out and subjected to compression forming, thereby producing cathode mixture pellets.

Next, 12.5 mg of the powder of the solid electrolyte material obtained in Production Example 1, was put in such a ceramic columnar mold, that the inner area of the transverse cross section was 1 cm². The powder in the mold was pressed at 98 MPa (1 ton/cm²) to form a solid electrolyte layer. The cathode mixture pellets produced above were disposed on one surface of the solid electrolyte layer and pressed at 98 MPa (1 ton/cm²) to form the cathode mixture. The anode mixture pellets obtained above were disposed on the other surface of the solid electrolyte layer and pressed at 588 MPa (6 ton/cm²) to form the anode mixture. As a cathode current collector, an aluminum foil was disposed on the cathode mixture. As an anode current collector, a copper foil was disposed on the anode mixture. As a result, a sulfide all-solid-state battery was obtained.

### Examples 2 to 14

### <Production of Anode Material Particles>

The anode material particles (2) to (14) of Examples 2 to 14 were obtained in the same manner as Example 1, except for the following: in the production of the anode material particles, the sputtering time under the vacuum atmosphere was controlled to ensure that the Si layer thickness would be the thickness shown in Table 1, and the sputtering time under the oxygen gas atmosphere was controlled to ensure that the SiO₂ layer thickness would be the void layer thickness shown in Table 1.

For the anode material particles (2) to (14) of Examples 2 to 14, in the same manner as Example 1, the inner structures of the anode material particles and the thicknesses of the layers of the anode material particles were checked, and the coverages of the coat films on the anode material particles and the median diameters (D50) of the anode material particles were obtained.

<Production of Anodes for Sulfide all-Solid-State Batteries and Production of Sulfide all-Solid-State Batteries>

The anodes for sulfide all-solid-state batteries of Examples 2 to 14 and the sulfide all-solid-state batteries of Example 2 to 14 were obtained in the same manner as Example 1, except for the following: in the production of the anode for sulfide all-solid-state batteries and the production of the sulfide all-solid-state battery, the anode material particles (2) to (14) were each used in place of the anode material particles (1), and the amount of the anode material particles incorporated in the slurry (the raw material for the anode mixture) was controlled to ensure that the amount of the incorporated Si-based material in the slurry would be the same as Example 1.

### Examples 15 and 16

### <Production of Anode Material Particles>

The anode material particles (15) and (16) of Examples 15 and 16 were obtained in the same manner as Example 1, except for the following: in the production of the anode material particles, the sputtering time under the vacuum atmosphere was controlled to ensure that the Si layer thickness would be the thickness shown in Table 1; the sputtering time under the oxygen gas atmosphere was controlled to ensure that the SiO₂ layer thickness would be the void layer thickness shown in Table 1; and the powder of the laminate was classified to ensure that the median diameter (D50) of the anode material particles would be the value shown in Table 1.

For the anode material particles (15) and (16) of Examples 15 and 16, in the same manner as Example 1, the inner structures of the anode material particles and the thicknesses of the layers of the anode material particles were checked, and the coverages of the coat films on the anode material particles and the median diameters (D50) of the anode material particles were obtained.

<Production of Anodes for Sulfide all-Solid-State Batteries and Production of Sulfide all-Solid-State Batteries>

The anodes for sulfide all-solid-state batteries of Examples 15 and 16 and the sulfide all-solid-state batteries of Examples 15 and 16 were obtained in the same manner as Example 1, except for the following: in the production of the anode for sulfide all-solid-state batteries and the production of the sulfide all-solid-state battery, the anode material particles (15) and (16) were each used in place of the anode material particles (1), and the amount of the anode material particles incorporated in the slurry (the raw material for the anode mixture) was controlled to ensure that the amount of the incorporated Si-based material in the slurry would be the same as Example 1.

### Comparative Examples 1 and 2

The anodes for sulfide all-solid-state batteries of Comparative Examples 1 and 2 and the sulfide all-solid-state batteries of Comparative Examples 1 and 2 were obtained in the same manner as Example 1, except for the following: in the production of the anode for sulfide all-solid-state batteries and the production of the sulfide all-solid-state battery, as shown in Table 1, Si particles having a median diameter (D50) of 2 μm and Si particles having a median diameter (D50) of 5 μm were each used in place of the anode material particles (1), and the amount of the Si particles incorporated in the slurry (the raw material for the anode mixture) was controlled to ensure that the amount of the incorporated Si-based material in the slurry would be the same as Example 1.

### <Evaluation for Pressure Increase Amounts>

The sulfide all-solid-state battery of Example 1 was sandwiched between the confining plates of a confining jig. A load cell was sandwiched between the confining plates and confined in the same pressure system. In such a state that a confining pressure of 1 MPa was applied thereto, the sulfide all-solid-state battery was charged with constant current and constant voltage (CC/CV charge) at 0.2 mA to 4.35 V. After the voltage of the battery reached 4.35 V, the current was attenuated with keeping the voltage value. The pressure that was applied to the confining jig before charge (hereinafter, the pressure is referred to as “P1”) and the pressure that was applied to the confining jig after charge (hereinafter, the pressure is referred to “P2”) were measured. A pressure increase value (ΔP) was obtained from the measured pressures P1 and P2 (ΔP=P2−P1). The pressure increase values (ΔP) of Examples 2 to 16 and Comparative Example 1 to 2 were obtained in the same manner as Example 1. In addition, the relative values of the pressure increase values (ΔP) of Example 1 to 16 and Comparative Example 2 were obtained when the pressure increase value (ΔP) of Comparative Example 1 was determined as 100. These relative pressure increase values are shown in Table 1.

For the anode material particles (1) to (16) of Examples 1 to 16, Table 1 also shows the following: the Si-based material layer thickness, the void layer thickness, the ratio (%) of the void layer thickness to the average Si-based material layer thickness (the ratio is simply referred to as “Void layer thickness/Si-based material layer thickness” in Table 1), the thickness and coverage of the coat film, and the median diameter (D50) of the anode material particles.

TABLE 1

| | Anode material particles | | | | | | |
|---|---|---|---|---|---|---|---|
| | | Void layer | | | | | |
| | | thickness/Si- | | | | | |
| | Si-based | based | | | | | |
| | material | material | | | | Median | Relative |
| | layer | layer | Void layer | Coat film | | diameter | pressure |
| | thickness | thickness | thickness | Thickness | Coverage | D50 | increase |
| | (nm) | (%) | (nm) | (nm) | (%) | (μm) | value |
| Example 1 | 80 | 37.5 | 30 | 80 | 83 | 5 | 38 |
| Example 2 | 80 | 10 | 8 | 80 | 84 | 5 | 74 |
| Example 3 | 80 | 97.5 | 78 | 80 | 84 | 5 | 33 |
| Example 4 | 300 | 17.3 | 52 | 80 | 83 | 5 | 74 |
| Example 5 | 300 | 40 | 120 | 80 | 84 | 5 | 56 |
| Example 6 | 300 | 50 | 150 | 80 | 84 | 5 | 54 |
| Example 7 | 80 | 38 | 30 | 80 | 83 | 5 | 38 |
| Example 8 | 201 | 35 | 70 | 80 | 84 | 5 | 39 |
| Example 9 | 450 | 31 | 140 | 80 | 84 | 5 | 43 |
| Example 10 | 82 | 51 | 42 | 80 | 83 | 5 | 41 |
| Example 11 | 203 | 52 | 105 | 80 | 84 | 5 | 57 |
| Example 12 | 300 | 50 | 150 | 80 | 83 | 5 | 54 |
| Example 13 | 453 | 55 | 250 | 80 | 83 | 5 | 49 |
| Example 14 | 300 | 50 | 150 | 80 | 83 | 5 | 54 |
| Example 15 | 300 | 50 | 150 | 80 | 84 | 9.3 | 57 |
| Example 16 | 300 | 50 | 150 | 80 | 83 | 20.5 | 61 |
| Comparative | — | — | — | — | — | 2 | 100 |
| Example 1 | | | | | | | |
| Comparative | — | — | — | — | — | 5 | 100 |
| Example 2 | | | | | | | |

As shown in Table 1, compared to Comparative Examples 1 and 2 in each of which the Si particles were used as the anode active material, an increase in the pressure applied to the confining jig after charge, was suppressed in Examples 1 to 16, due to the use of the specific anode material particles each comprising the laminate which comprises the void layers and the Si-based material layers and in which the Si-based material layers and the void layers are alternately laminated, and each comprising the coat film covering the surface of the laminate to cover at least the void layers. In Examples 1 to 16, since the expansion of the specific anode material particles was suppressed during charge, the expansion of the anode containing the specific anode material particles and the expansion of the battery itself were suppressed. Accordingly, it is presumed that an increase in the pressure applied to the confining jig after charge, was suppressed.

### Example 17

### <Production of Anode Material Particles>

The anode material particles (17) of Example 17 were obtained in the same manner as Example 1, except for the following: in the production of the anode material particles, the sputtering time under the vacuum atmosphere was controlled to ensure that the Si layer thickness would be 101 nm; the sputtering time under the oxygen gas atmosphere was controlled to ensure that the SiO₂ layer thickness would be 134 nm; the formalin concentration of the resorcinol-formalin solution was increased; after the powder was immersed in hydrofluoric acid, the powder was further immersed in an ethanol solution containing the solid electrolyte material obtained in Production Example 1 at a concentration of 5 mass %, and then the powder was dried, thereby forming solid electrolyte material layers on the void layer-side surfaces of the Si layers.

For the anode material particles, a SEM image of the cross-sections of the particles were taken. The inner structure of each anode material particle and the thicknesses of the layers of each anode material particle, were checked by the SEM image of the cross section of each anode material particle. As a result, it was found that each anode material particle (17) comprised the following laminate: the laminate comprised Si-based material layers each having a thickness of 101 nm (the Si-based material layers were Si layers), void layers each having a thickness of 110 nm, and solid electrolyte material layers each having a thickness of 12 nm; in the laminate, the Si-based material layers and the void layers were alternately laminated; and on the void layer-side surfaces of the Si-based material layers, the solid electrolyte material layers were disposed adjacent to the void layers. It was also found that each anode material particle (17) comprised a coat film having a thickness of 30 nm and covering the surface of the laminate to cover at least the void layers (the coat film was a carbon coat film).

For the anode material particles (17) of Example 17, the coverage of the coat film and the median diameter (D50) of the anode material particles were also obtained in the same manner as Example 1.

<Production of an Anode for Sulfide all-Solid-State Batteries and Production of a Sulfide all-Solid-State Battery>

An anode for sulfide all-solid-state batteries of Example 17 and a sulfide all-solid-state battery of Example 17 were obtained in the same manner as Example 1, except for the following: in the production of the anode for sulfide all-solid-state batteries and the production of the sulfide all-solid-state battery, the anode material particles (17) of Example 17 were used in place of the anode material particles (1) of Example 1, and the amount of the anode material particles incorporated in the slurry (the raw material for the anode mixture) was controlled to ensure that the amount of the incorporated Si-based material in the slurry would be the same as Example 1.

### Examples 18 to 34

The anode material particles (18) to (34) of Examples 18 to 34 were obtained in the same manner as Example 17, except for the following: in the production of the anode material particles, the sputtering time under the vacuum atmosphere was controlled to ensure that the Si layer thickness would be the thickness shown in Table 2; the sputtering time under the oxygen gas atmosphere was controlled to ensure that the thickness of the SiO₂ layer would be a thickness obtained by adding, to the void layer thickness shown in Table 2, the thickness that is twice the solid electrolyte material layer (SE layer) thickness, that is, the thickness calculated by the following formula: “the void layer thickness”+“the SE layer thickness”×2; and the concentration of the solid electrolyte material in the ethanol solution containing the solid electrolyte material, was changed to ensure that the solid electrolyte material layer thickness would be the thickness shown in Table 2.

For the anode material particles (18) to (34) of Examples 18 to 34, in the same manner as Example 1, the inner structures of the anode material particles and the thicknesses of the layers of the anode material particles were checked, and the coverages of the coat films on the anode material particles and the median diameters (D50) of the anode material particles were obtained.

<Production of Anodes for Sulfide all-Solid-State Batteries and Production of Sulfide all-Solid-State Batteries>

The anodes for sulfide all-solid-state batteries of Examples 18 to 34 and the sulfide all-solid-state batteries of Examples 18 to 34 were obtained in the same manner as Example 1, except for the following: in the production of the anode for sulfide all-solid-state batteries and the production of the sulfide all-solid-state battery, the anode material particles (18) to (34) were each used in place of the anode material particles (1), and the amount of the anode material particles incorporated in the slurry (the raw material for the anode mixture) was controlled to ensure that the amount of the incorporated Si-based material in the slurry would be the same as Example 1.

### <Evaluation for Resistance Increase Amount>

In the same manner as the pressure increase amount evaluation, the sulfide all-solid-state battery of Example 17 was combined with the confining jig. In such a state that a confining pressure of 1 MPa was applied thereto, the sulfide all-solid-state battery was charged with constant current and constant voltage (CC/CV charge) at 0.2 mA to 4.35 V. After the voltage value of the battery reached 4.35 V, the current was attenuated with keeping the voltage value. Then, the sulfide all-solid-state battery was discharged with constant current and constant voltage (CC/CV discharge) at 0.2 mA to 3.0 V; moreover, the sulfide all-solid-state battery was charged with constant current and constant voltage (CC/CV charge) at 0.2 mA to 3.7 V. After the voltage value reached 3.7 V, the current was attenuated with keeping the voltage value. Then, a DC-IR was measured from a decrease in voltage when the battery was discharged at 14 mA for 5 seconds, and it was determined as the initial resistance value of the battery. Also, a DC-IR was measured from a decrease in voltage when the battery was charged and discharged with constant current (CC charge and discharge) at 4 mA from 3.2 V to 4.0 V for 600 cycles and then was discharged at 14 mA for 5 seconds, and it was determined as the post-cycle resistance value of the battery. The post-cycle resistance value was divided by the initial resistance value (the post-cycle resistance value/the initial resistance value), and the thus-obtained value was determined as the resistance increase rate. The resistance increase rates of Examples 18 to 34 were obtained in the same manner as Example 17.

The relative values of the resistance increase rate of Example 17 to 34 when the resistance increase rate of Comparative Example 2 was determined as 100, were obtained as the relative resistance increase values. The relative resistance increase values are shown in Table 2.

For the anode material particles (17) to (34) of Examples 17 to 34, Table 2 shows the following: the Si-based material layer thickness, the void layer thickness, the solid electrolyte material layer thickness (the solid electrolyte material layer is referred to as “SE layer” in Table 2), the ratio (%) of the void layer thickness to the average Si-based material layer thickness (the ratio is simply referred to as “Void layer thickness/Si-based material layer thickness” in Table 2), the ratio (%) of the solid electrolyte material layer thickness to the average Si-based material layer thickness (the ratio is simply referred to as “SE layer thickness/Si-based material layer thickness” in Table 2), the thickness and coverage of the coat film, and the median diameter (D50) of the anode material particles.

TABLE 2

| | Anode material particles | | | | | | | | |
|---|---|---|---|---|---|---|---|---|---|
| | | Void layer | | SE layer | | | | | |
| | | thickness/Si- | | thickness/Si- | | | | | |
| | Si-based | based | | based | | | | | |
| | material | material | | material | | | | Median | Relative |
| | layer | layer | Void layer | layer | SE layer | Coat film | | diameter | resistance |
| | thickness | thickness | thickness | thickness | thickness | Thickness | Coverage | D50 | increase |
| | (nm) | (%) | (nm) | (%) | (nm) | (nm) | (%) | (μm) | value |
| Example 17 | 101 | 109 | 110 | 12 | 12 | 30 | 81 | 5 | 91 |
| Example 18 | 101 | 111 | 112 | 21 | 21 | 30 | 82 | 5 | 90 |
| Example 19 | 101 | 114 | 115 | 35 | 35 | 30 | 82 | 5 | 89 |
| Example 20 | 220 | 106 | 233 | 11 | 25 | 30 | 81 | 5 | 93 |
| Example 21 | 220 | 107 | 235 | 18 | 40 | 30 | 81 | 5 | 93 |
| Example 22 | 220 | 109 | 240 | 30 | 65 | 30 | 81 | 5 | 91 |
| Example 23 | 60 | 110 | 66 | 23 | 14 | 30 | 81 | 5 | 92 |
| Example 24 | 101 | 109 | 110 | 21 | 21 | 30 | 81 | 5 | 90 |
| Example 25 | 220 | 105 | 230 | 23 | 51 | 30 | 81 | 5 | 88 |
| Example 26 | 316 | 104 | 330 | 25 | 80 | 30 | 81 | 5 | 89 |
| Example 27 | 60 | 108 | 65 | 37 | 22 | 30 | 82 | 5 | 90 |
| Example 28 | 101 | 114 | 115 | 35 | 35 | 30 | 82 | 5 | 89 |
| Example 29 | 220 | 106 | 234 | 35 | 78 | 30 | 81 | 5 | 87 |
| Example 30 | 316 | 107 | 338 | 36 | 114 | 30 | 82 | 5 | 86 |
| Example 31 | 101 | 109 | 110 | 21 | 21 | 30 | 82 | 5 | 90 |
| Example 32 | 102 | 132 | 135 | 21 | 21 | 30 | 81 | 5 | 90 |
| Example 33 | 220 | 107 | 235 | 18 | 40 | 30 | 82 | 5 | 93 |
| Example 34 | 225 | 124 | 279 | 20 | 44 | 30 | 81 | 5 | 91 |
| Comparative | — | — | — | — | — | — | — | 5 | 100 |
| Example 2 | | | | | | | | | |

As shown in Table 2, compared to Comparative Example 2 in which the Si particles were used as the anode active material, an increase in resistance after repeating charge and discharge, was suppressed in Examples 17 to 34, due to the use of the specific anode material particles each comprising the laminate which comprises the Si-based material layers, the void layers and the solid electrolyte material layers and in which the Si-based material layers and the void layers are alternately laminated and on the void layer-side surfaces of the Si-based material layers, the solid electrolyte material layers are disposed adjacent to the void layers, and each comprising the coat film covering the surface of the laminate to cover at least the void layers. In Examples 17 to 34, since the expansion of the specific anode material particles was suppressed during charge, a gap is less likely to be created between the anode material particle surface and the solid electrolyte. In addition, since the Si-based material layers are in contact with the solid electrolyte material layers inside the specific anode material particles, the contact area between the Si-based material layers and the solid electrolyte is large, and excellent lithium ion conduction to the Si-based material layers are obtained. Accordingly, it is presumed that an increase in resistance after repeating charge and discharge was suppressed.

### REFERENCE SIGNS LIST

1. Si-based material layer
2. Void layer
3. Coat film
4. Solid electrolyte
4a. Solid electrolyte material layer
10. Anode material particle
20. Anode mixture
30A. Anode for sulfide all-solid-state batteries before charge
30B. Anode for sulfide all-solid-state batteries after charge
30C. Anode for sulfide all-solid-state batteries before charge
30D. Anode for sulfide all-solid-state batteries after charge
11. Solid electrolyte layer
12. Cathode mixture
13. Anode mixture
14. Cathode current collector
15. Anode current collector
16. Cathode
17. Anode
100. Sulfide all-solid-state battery

1. An anode for sulfide all-solid-state batteries,
wherein the anode comprises anode material particles, and
wherein each anode material particle comprises
a laminate which comprises void layers and Si-based material layers containing at least one Si-based material selected from the group consisting of Si and a Si alloy, and in which the Si-based material layers and the void layers are alternately laminated, and
a coat film covering a surface of the laminate to cover at least the void layers.

2. The anode for sulfide all-solid-state batteries according to claim 1, wherein the coat film contains a carbonaceous material.

3. The anode for sulfide all-solid-state batteries according to claim 1, wherein a thickness of each Si-based material layer is 50 nm or more and 500 nm or less, and a thickness of each void layer is 10% or more of an average thickness of the Si-based material layers.

4. The anode for sulfide all-solid-state batteries according to claim 1, wherein a median diameter (D50) of the anode material particles is 2 μm or more and 20.5 μm or less.

5. The anode for sulfide all-solid-state batteries according to claim 1, wherein each anode material particle further comprises solid electrolyte material layers containing a solid electrolyte material, and on void layer-side surfaces of the Si-based material layers of the laminate, the solid electrolyte material layers are disposed adjacent to the void layers.

6. The anode for sulfide all-solid-state batteries according to claim 5, wherein a thickness of each solid electrolyte material layer is 10% or more and 50% or less of the average thickness of the Si-based material layers.

7. A sulfide all-solid-state battery comprising the anode for sulfide all-solid-state batteries defined by claim 1.
